(19) United States
(12) Patent Application Publication
(10) Pub. No.: US 2017/0069002 A1
(43) Pub. Date: Mar. 9, 2017

(54) Systems and Methods for Identifying Aggregate Merchants

(71) Applicant: MASTERCARD INTERNATIONAL INCORPORATED, Purchase, NY (US)

(72) Inventors: Matthew S. Morice, St. Charles, MO (US); Walter F. Lo Faro, Chesterfield, MO (US)

(21) Appl. No.: 14/848,748

(22) Filed: Sep. 9, 2015

(51) Int. Cl. G06Q 30/06

(52) U.S. Cl. CPC G06Q 30/0605

(57) ABSTRACT

Systems and methods for use in identifying one or more aggregate merchants are provided. An exemplary method includes compiling, by a computing device, a merchant data structure based on a region where the merchant data structure includes multiple merchants and, for each of the multiple merchants, a Doing Business As (DBA) name and at least one merchant metric. The exemplary method further includes aggregating, by the computing device, ones of the multiple merchants in the merchant data structure based on at least one rule including a Doing Business As (DBA) name and/or at least one Merchant Category Code (MCC). The method also includes sorting, by the computing device, the aggregate merchants in the merchant data structure based on at least one merchant metric, and then publishing the sorted aggregate merchants to a user.

### FIELD

The present disclosure generally relates to systems and methods for identifying aggregate merchants and, in particular, to identifying aggregate merchants, in the same region, based on at least one criteria related to the merchants.

### BACKGROUND

This section provides background information related to the present disclosure which is not necessarily prior art.

Payment accounts are used by consumers to perform numerous different transactions including, for example, purchasing products such as goods and/or services from merchants, etc. Transaction data is often generated in connection with the purchase transactions. The transaction data can then be used, for example, to provide insight into purchasing behavior of consumers and/or transaction patterns of and other details related to merchants. In one or more instances, to gain this insight, analysts correlate transaction data per merchants, often regardless of whether the merchants are single location merchants or multiple location merchants (i.e., chain merchants).

### DRAWINGS

The drawings described herein are for illustrative purposes only of selected embodiments and not all possible implementations, and are not intended to limit the scope of the present disclosure.

FIG. 1 shows an exemplary system for identifying aggregate merchants, and including one or more aspects of the present disclosure;

FIG. 2 is a block diagram of an exemplary computing device, suitable for use in the system of FIG. 1; and

FIG. 3 is a flowchart of an exemplary method, which can be implemented via the system of FIG. 1, for identifying aggregate merchants in the same region and industry, based on at least one criteria related to the merchants.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Transaction data is often compiled by payment networks, for example, in connection with payment device transactions by consumers at merchants. The transaction data may be aggregated, culled, divided, and/or analyzed in a number of different ways to gain insight into and/or awareness of various characteristics of the transactions, for merchants and/or consumers involved in the transactions, etc. The systems and methods herein identify one or more aggregate merchants (i.e., merchants having multiple different locations such as chain merchants) based on select criteria, for example, for particular merchants in a region, or for a top number of merchants in a region for a particular category (or industry), etc. In particular in the systems and methods, merchants in a selected region are compiled into an aggregate merchant data structure. The merchants in the data structure are then limited, aggregated and/or sorted based on “Doing Business As” or DBA name, MCC, and/or one or more merchant metrics, whereby the resulting group of aggregate merchants can provide insight consistent with the inquiry about merchants in the region.

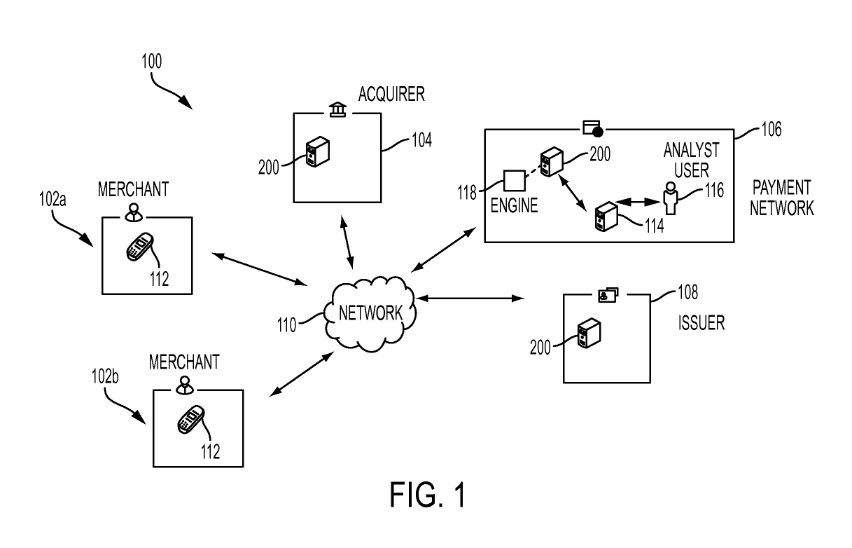

FIG. 1 illustrates an exemplary system 100 in which one or more aspects of the present disclosure may be implemented. Although parts of the system 100 are presented in one arrangement, it should be appreciated that other exemplary embodiments may include the same or different parts arranged otherwise, depending on, for example, processing of payment transactions, access to transaction data, aggregation of merchants, etc.

As shown in FIG. 1, the illustrated system 100 generally includes merchants 102a-b, an acquirer 104, a payment network 106, and an issuer 108, each coupled to a network 110. The network 110 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In one example, the network 110 includes multiple networks, where different ones of the multiple networks are accessible to different ones of the illustrated parts in FIG. 1. In particular in this example, the acquirer 104, the payment network 106, and the issuer 108 may be connected via a private network that is part of network 110 for processing payment transactions, and the merchants 102a-b may be connected with consumers, for example, through a public network, such as the Internet, that is also part of network 110.

Generally in the system 100, one of the merchants 102a-b, the acquirer 104, the payment network 106, and the issuer 108 cooperate, in response to a consumer (not shown) (e.g., a purchase by the consumer), to complete a purchase transaction. In this exemplary embodiment, the merchants 102a-b represent two different locations of the same merchant (i.e., two different locations of aggregate merchant 102). As such, purchase transactions at either of the merchants 102a-b generally represent purchase transactions to aggregate merchant 102. Further, as shown in FIG. 1, the merchants 102a-b each include point of sale (POS) terminals 112. The POS terminals 112 are used by the merchants 102a-b to facilitate the purchase transactions with the consumer for products offered for sale by the merchants 102a-b. The POS terminals 112 are typically associated with identifications that correlate them to the appropriate one of the merchants 102a-b, or to the aggregate merchant 102 in general (depending on programming of the POS terminals 112).

As an example, in a credit transaction by the consumer at merchant 102a, the consumer initiates the transaction by presenting a payment device, such as a card, a payment token, a payment tag, a pass, another device used to provide an account number (e.g., a mobile phone, a tablet, etc.), etc., to merchant 102a. The merchant 102a reads the payment device (associated with a payment account), at POS terminal 112, and communicates an account number and an amount of the purchase to the acquirer 104 through the network 110 to determine if the consumer's payment account is in good standing and if there is/are sufficient credit/funds to complete the transaction. The acquirer 104, in turn, communicates with the issuer 108, through the payment network 106, via the network 110, for authorization for the transaction. If the issuer 108 accepts the transaction, an authorization is provided back to the merchant 102a and the merchant 102a completes the transaction. The credit line or funds of the consumer, depending on the type of payment account, is then decreased by the amount of the purchase, and the charge is posted to the account associated with the payment device. The transaction is later cleared and settled by and between the merchant 102a and the acquirer 104 and by and between the acquirer 104 and the issuer 108 (in accordance with another settlement arrangement, etc.). Certain accounts, such as debit payment accounts, may further include the use of a personal identification number (PIN) authorization, or other authorization mechanisms, and/or more rapid posting of the charge to the account associated with the card, etc.

Transaction data is generated, collected, and stored as part of the above interactions among the merchant 102a, the acquirer 104, the payment network 106, the issuer 108, and the consumer. The transaction data represents at least a plurality of transactions, e.g., completed transactions, attempted transactions, etc. The transaction data, in this exemplary embodiment, is stored at least by the payment network 106 (e.g., in a data structure associated with the payment network 106, etc.). Additionally, or alternatively, the merchant 102a, the acquirer 104, and/or the issuer 108 may store the transaction data, or part thereof, in a data structure. Or transaction data may be transmitted between the different parts of the system 100, as used or needed. The transaction data may be stored in any desired manner in the system 100. For example, transaction data relating to purchase transactions at merchants 102a-b may be combined at the payment network 106, based on merchant ID, or other data common to the merchants 102a-b, when stored, since merchants 102a-b represent two different locations of the same aggregate merchant 102. In this manner, the transaction data is representative of the aggregate merchant 102 in total, and not the individual merchants 102a-b. However, it should be appreciated that the transaction data for merchants 102a-b may also, or alternatively, be stored in the system 100, at the payment network 106, separately so that a further representation of the particular different locations of the aggregate merchant 102 is also provided/available, or particular aggregates process, such as those described herein, may be used.

With that said, transaction data may include, for example, payment account numbers, amounts of transactions, merchant IDs, merchant category codes (MCCs), region codes (or other location identifiers) for merchants involved in transactions (or POS terminals associated with the merchants), “Doing Business As” (DBA) name (e.g., short DBA name (i.e., a reduced version of the DBA name, such as, the DBA name with all spaces removed) etc.), dates/times of transactions, products purchased and related descriptions or identifiers, etc. It should be appreciated that more or less information related to transactions, as part of either authorization and/or clearing and/or settling, may be included in transaction data and stored within the system 100, at the merchants 102a-b, the acquirer 104, the payment network 106, and/or the issuer 108. Further, transaction data, unrelated to a particular payment account, may be collected by a variety of techniques, and similarly stored within the system 100.

In various exemplary embodiments, consumers to merchants 102a-b involved in the different transactions herein have agreed to legal terms associated with their payment accounts, for example, during enrollment in their accounts, etc. In so doing, the consumers may voluntarily agree, for example, to allow merchants, issuers of the payment accounts, payment networks, etc. to use data collected during enrollment and/or collected in connection with processing the transactions, subsequently for one or more of the different purposes described herein.

With further reference to FIG. 1, while only two merchants 102a-b, one acquirer 104, one payment network 106, one issuer 108, and one user 112 are illustrated in FIG. 1 (for ease of reference), it should be appreciated that a variety of other embodiments may include multiple ones of these entities, as well as multiple consumers, in various combinations and, in some of these embodiments, hundreds or thousands of certain ones of these entities. Further, while none are illustrated in FIG. 1, it should be appreciated that any number of consumers may be included in, or accommodated by, the system 100.

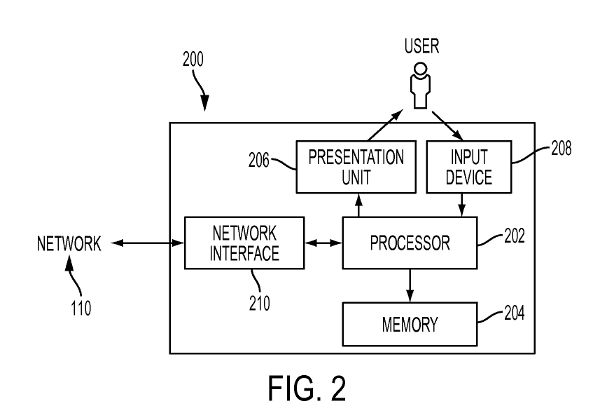

FIG. 2 illustrates an exemplary computing device 200 that can be used in the system 100. The computing device 200 may include, for example, one or more servers, workstations, personal computers, laptops, tablets, smartphones, other suitable computing devices, etc. In addition, the computing device 200 may include a single computing device, or it may include multiple computing devices located in close proximity, or multiple computing devices distributed over a geographic region, so long as the computing devices are specifically configured, alone or in combination, to function as described herein. In the system 100, each of the acquirer 104, the payment network 106, and the issuer 108 are illustrated as including, or being implemented in, computing device 200, coupled to the network 110. Also in the system 100, POS terminals 112 associated with the merchants 102a-b and computing device 114 associated with the payment network 106 are each consistent with computing device 200. However, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 generally includes a processor 202 and a memory 204 coupled to the processor 202. The processor 202 may include one or more processing units (e.g., in a multi-core configuration, etc.) including, without limitation, a central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and are not intended to limit in any way the definition and/or meaning of processor.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204, and/or data structures included therein, may be configured to store, without limitation, transaction data, listings of aggregate merchants, short DBA names for merchants, MCCs for merchants, region codes or location identifiers for merchants, transaction metrics for merchants (e.g., total spend per aggregate merchant, etc.), merchant metrics (e.g., number of locations, transaction metrics, etc.), and/or other types of data and/or information suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. It should be appreciated that the memory 204 may include a variety of different memories, each implemented in one or more of the functions or processes described herein.

The computing device 200 also includes a presentation unit 206 (or output device or display device) that is coupled to the processor 202 (however, it should be appreciated that the computing device 200 could include output devices other than the presentation unit 206, etc.). The presentation unit 206 outputs information, either visually or audibly to a user of the computing device 200, for example, a consumer, analyst user 116 associated with the payment network 106 in the system 100, individuals associated with other parts of the system 100, etc. It should be further appreciated that various interfaces (e.g., application interfaces, webpages, etc.) may be displayed at computing device 200, and in particular at presentation unit 206, to display information, such as, for example, lists of sorted aggregate merchants, etc. The presentation unit 206 may include, without limitation, a liquid crystal display (LCD), a light-emitting diode (LED) display, an organic LED (OLED) display, an “electronic ink” display, etc. In some embodiments, presentation unit 206 includes multiple devices.

The computing device 200 further includes an input device 208 that receives inputs from the user of the computing device 200 (i.e., user inputs) such as, for example, identifying criteria for aggregate merchants, requesting to identify aggregate merchants, confirming manual review, etc. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. In various exemplary embodiments, a touch screen, such as that included in a tablet, a smartphone, or similar device, behaves as both a presentation unit and an input device.

In addition, the illustrated computing device 200 also includes a network interface 210 coupled to the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 includes the processor 202 and one or more network interfaces incorporated into or with the processor 202.

Referring again to FIG. 1, the payment network 106 further includes an aggregation engine 118, which is specifically configured, often by executable instructions, to cause a processor (e.g., processor 202, etc.), for example, to perform on or more of the operations as described herein. The engine 118 may be a standalone computing device consistent with computing device 200, or it may be incorporated in the payment network's computing device 200 (as generally indicated by the dotted lines in FIG. 1). Further still, the engine 118 may be included in part, or in whole, in other parts of FIG. 1, including, for example, the acquirer 104 and/or the issuer 108, etc.

In the system 100, the aggregation engine 118 operates in cooperation with the computing device 114 as directed, or as controlled, by the analyst user 116. In particular, the user 116 may, from time to time, desire to identify aggregate merchants based on one or more criteria. The analyst user 116 is associated with the payment network 106, as an employee, for example, who responds to client inquires for aggregate merchants based on, for example, region, industry, or other criteria, etc. Clients, which submit inquiries to the analyst user 116, may be internal to the payment network 106 (e.g., in certain business units or divisions, etc.), or external to the payment network 106. The inquiries are often based on one or more business objectives, for which identifying top merchants in a region, based on one or more criteria, is desirable. In the system 100, the user 116, in turn, provides a request to the engine 118, which includes the criteria related to a region and/or an industry and/or other criteria (e.g., as specified to the analyst user 116 in the client inquiry, etc.).

In response to a request from the analyst user 116, the aggregation engine 118 compiles a data structure of merchants, from available merchants stored in memory 204 (of the payment network's computing device 200), for example, based on a particular region specified by the user 116. The region may include, without limitation, a country, a state, a county, a zip code, an area code, or other defined geographic region, etc. As an example, the region (in the request) may include a country for which a region code is included in the user's request. Or, the particular county may be included in the user's request for which the engine 118 identifies a region code. In either case, the engine 118 then identifies merchants, from the payment network 106, based on the region code. In some implementations of the system 100, the engine 118 may also limit the data structure to merchants in a particular industry (e.g., based on industry codes, a particular MCC, a particular group of MCCs, etc.), for example, when included in the request (and/or to merchants satisfying any additional criteria specified in the request or client inquiry).

After the data structure is compiled, the aggregation engine 118 aggregates merchants therein based on various rules relating to matches in merchant names (e.g., short DBA names, etc.) and MCCs. In some implementations of the system 100, the engine 118 also limits, or filters, the merchants or aggregate merchants based on a particular MCC or multiple MCCs. The engine 118 is configured to next sort the aggregate merchants, for example, based on the user's request by use of one or more merchant metrics (e.g., total transactions, total spend, etc.). The engine 118 is further configured to then provide a list of aggregate merchants to the user 116 including, for example, displaying the list to the user 116 at presentation unit 206 of the user's computing device 114. The user 116 then provides manual review of the list of sorted aggregate merchants and, if it appears accurate, the aggregation engine 118 is directed, by the analyst user 116, to (and does) publish the list of aggregate merchants to the client, for example, or other party as appropriate. However, if the user 116 does not confirm the list (e.g., the aggregation appears to have missed several merchants, etc.), the aggregation engine 118 is configured to attempt to generate additional rules for aggregation (e.g., short DBA name and MCC pairs, etc.), as described more hereinafter. Upon generation of additional rules, of generally after review by the analyst user 116, the engine 118 is configured to revisit one or more of the operations above to provide append different MCC/industries to the data structure of merchants, otherwise filter the merchants, and/or otherwise modify and/or revise the above operation, whereby the sorted aggregate merchants are then reviewed again by the analyst user 116. The engine 118 may be directed, by the user 116, to continue until the sorted list of aggregated merchants is reflective of the inquiry submitted by the client, before then publishing the list to the client, or other party as appropriate.

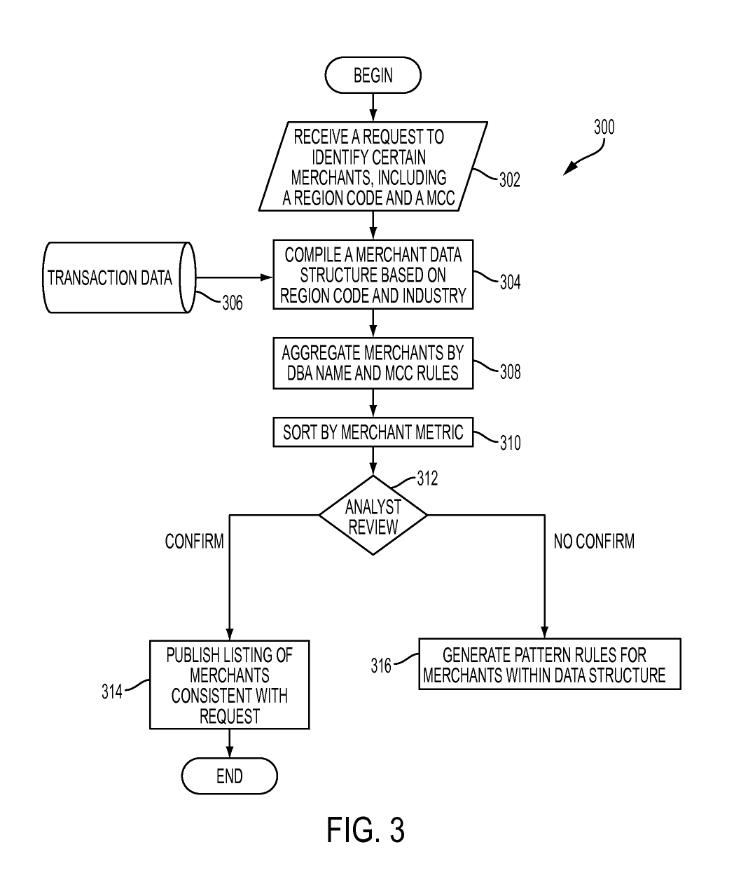

FIG. 3 illustrates an exemplary method 300 for use in identifying aggregate merchants. The exemplary method 300 is described as implemented in the payment network 106 of the system 100 and, more particularly, in the engine 118 thereof. Further, for purposes of illustration, the exemplary method 300 is described herein with reference to other parts of the system 100 and the computing device 200. As should be understood, however, the methods herein should not be understood to be limited to the exemplary system 100 or the exemplary computing device 200, and the systems and the computing devices herein should not be understood to be limited to the exemplary method 300.

Generally in the method 300, a client to the system 100, and in particular, within the payment network 106, for example, or otherwise, inquiries into, or requests information about, merchants in a particular region or in a particular industry, and often more particularly about such merchants consistent with one or more particular criteria. For example, the client may request a listing of the top five eating places in a region (broadly, a criteria), or a listing of the top ten men's clothing retailers in a country (broadly, a criteria), or a listing of the top 20 grocery stores in a country (broadly, a criteria). For instances in which non-transaction information about the desired region is readily available and/or familiar to the client (e.g., country of interest, etc.), identification of such merchants may be done outside of the payment network 106, for example. The exemplary methods herein, however, substantially involve transaction data, as a real and objective measure of merchant and/or transaction activity in a region, often limiting the necessity for outside sources of information and/or familiarity with a particular region (except, potentially, for verification purposes).

Based on the inquiry by the client (whether internal or external to the payment network 106), the analyst user 116 generates a request for the aggregation engine 118 specific to the clients' inquiry. The request generally includes, or identifies, the region of interest commensurate with the client's inquiry, which may be one or more countries, states, counties, postal codes, or other defined geographic regions. In the method 300, the region is a country identified by the client. In turn, the user 116 includes a region code for the country in the request. Alternatively, the aggregation engine 118 may identify the region code independently from one or more region code data structures (apart of computing device 200 of the payment network 106, or elsewhere), by looking-up or otherwise searching for the country identified in the request. The request further includes a particular industry (or group of industries) of interest to the client, for example, eating places, clothing retailers, grocery stores, etc. The particular industry may be indicated in the request in a variety of different ways including, for example, by name, by industry code(s), by MCCs, or by multiple MCCs each of which are associated with the desired industry (or subset of the desired industry). The request, as compiled by the user 116, is then submitted to the engine 118.

In turn in the method 300, the aggregation engine 118 receives the request from the analyst user 116, at 302. In some embodiments, the engine 118 also stores the request in memory 204. As described, the request includes criteria, upon which the engine 118 identifies aggregate merchants within the identified region (i.e., merchants having the same region code as included in the request or as identified by the engine 118) and, if specified in the request, that are further in the identified industry and/or are associated with the identified MCC(s). In other embodiments, it is contemplated that the engine 118 may instead receive the request directly from the client, for example, via a suitable web-based applications (e.g., a website, an application programming interface (API), etc.) or other communication medium made available to the client through the payment network 106. In these embodiments, the analyst user 116 may then still communicate with and/or provide direction to the aggregation engine 118 as described below.

Next in the method 300, upon receiving the request from the user 116, the aggregation engine 118 compiles, at 304, a merchant data structure based on the region code and industry included in the request. In so doing, the engine 118 accesses transaction data 306, in the payment network 106, and retrieves transaction data for all merchants having a region code that matches the region code in the request, for inclusion in the data structure. The compiled data structure includes individual listings of merchants retrieved from the transaction data 306.

The aggregation engine 118 then aggregates the individual merchants within the data structure, at 308, based on short DBA name and MCC. In particular, the engine aggregates (e.g., combines, etc.) all merchants having the same short DBA name and the same MCC into one entry in the data structure. As such, different locations of the same merchant are aggregated into an “aggregate merchant” within the data structure (e.g., merchants 102a-b in system 100 are aggregated, or combined, into aggregate merchant 102, etc.). More generally, in connection with compiling the merchant data structure at 304 and aggregating the individual merchants therein at 308, various pattern rules are known to the payment network 106 for combining single merchants (or single merchant entries) to aggregate merchants (and are stored in memory 204). In the method 300, for example, the pattern rules are based on pairs of short DBA names and MCCs (e.g., SUBWAY and 5814, etc.). The pattern rules operate, as indicated, to combine like merchants, separately represented in the transaction data 306, into an aggregate merchant. It should be appreciated that other pattern rules, indicative of aggregate merchants, may be used, where the pattern rules are based on other criteria associated with the merchants.

Further in the method 300, after aggregating the individual merchants in the merchant data structure, the aggregation engine 118 populates the data structure with certain data associated with the aggregate merchants. For example, for each of the aggregate merchants included as an entry in the merchant data structure, the engine 118 may populate particular fields such as a short DBA name, a MCC, an industry code, a number of merchant locations have the same MCC and short DBA name, a total volume of transactions (or total spend), a total number of transactions, a number of customers, etc. Moreover, and specifically regarding transaction summaries or totals, the engine 118 may populate the fields based on data within a predefined interval (e.g., one week, one month, one quarter, etc.). For example, a total number of transactions may be for a last calendar year, etc. It should be appreciated that the engine 118 may further populate the data structure with any suitable data (based on any suitable fields), such that different data (and different fields) may be used or populated in merchant data structures compiled by the engine 118, at 304, in other embodiments.

Depending on the request from the client, and the number of aggregate merchants included in the merchant data structure, further filtering of the transaction data may be employed. Specifically, the merchant data structure includes, based on the above, all aggregate merchants in a particular region (or country, in this example) and a particular industry. The user 116 may opt to limit the aggregate merchant to a particular MCC, or further limit the region (e.g., to a particular state, city, zip code, etc.), for a variety of reasons or as suggested by the client's inquiry. For example, the engine 118 may filter the aggregate merchants based on MCC, or multiple MCCs or one or more other criteria. In such an example, all of the eating place (or EAP) industries may be reduced, by the engine 116, to MCC 5814 (i.e., the fast food restaurants category), etc. In this manner, the aggregation engine 118 may identify particular aggregate merchants of interest (based on the client's request).

An example merchant data structure is shown in Table 1 with fields for a short DBA name, a MCC, an industry code, a number of merchant locations, a total volume of transactions, and a total number of transactions shown populated for four different aggregate merchants, Merchants A-D.

TABLE 1

| | | | Number | Total | Total |
|---|---|---|---|---|---|
| Short DBA | | Industry | of | Transaction | Number of |
| Name | MCC | Code | Locations | Volume | Transactions |
| MerchantA | 5814 | EAP | 26379 | $1,500,000 | 100000 |
| MerchantB | 5331 | DVG | 11599 | $2,500,000 | 200000 |
| MerchantC | 5541 | AFS | 10715 | $3,500,000 | 150000 |
| MerchantD | 5814 | EAP | 6920 | $500,000 | 50000 |

With continued reference to FIG. 3, the engine 118 next sorts (e.g., orders, etc.) the aggregate merchants in the merchant data structure based on one or more merchant metrics, at 310. The merchant metrics may include a variety of different metrics relating to the aggregate merchants such as, for example, the total number of locations for an aggregate merchant, the total sales for an aggregate merchant, the total numbers of transactions for an aggregate merchant, a total number of customers, etc. The merchant metrics for total sales for an aggregate merchant and total numbers of transactions for an aggregate merchant represent transaction metrics, which are specific to transactions to the particular aggregate merchant. Generally, transaction metrics will be limited to a predefined interval, such as, for example, 30 days, six months, one year, five years, or some other interval of interest to the user 116 and/or client associated with the request. In Table 1, for example, the aggregate merchants are sorted based on the merchant metric for total number of merchant locations.

It should be appreciated that any suitable merchant metric may be included in the merchant data structure, or not, and used to sort the aggregate merchants, at 310. In some embodiments, certain merchant metrics are used based on the query by the client and the request from the user 116. If, for example, the client is interested in the top twenty sandwich shops, by revenue, for a region, the engine 118 will include the merchant metric for total sales in the data structure, rather than (or in addition to) a total number of locations. In this example, as a result, sorting the aggregate sandwich shop merchants, at 310, would then list the merchants in the order of total sales. Again, it should be appreciated that other merchant metrics may be used by the engine 118 or selected (or specified) by the user 116 to provided sorted aggregate merchants consistent with the client's query.

Once the aggregate merchants are sorted at 310, the user 116 performs a manual review of the aggregate merchants, at 312, and either confirms or does not confirm the merchant data structure (and the listing of sorted aggregate merchants therein).

The user 116 may rely on a variety of experiences and/or intuitions about the listing of aggregate merchants to determine whether to confirm or not confirm the listing. As an example, one of the top aggregate merchants in the merchant data structure may be “ABC Sandwich Shop”, with 55 locations and an industry code of EAP. Another one of the aggregate merchants in the merchant data structure may be “ABV Sandwich Shop”, having 7 locations and an industry code of EAP. Upon discovering these two aggregate merchants, the user 116 may investigate to determine if “ABV Sandwich Shop” is part of the same aggregate merchant as “ABC Sandwich Shop”. This may include, for example, one or more web searches for either, or both, “ABV Sandwich Shop” and “ABC Sandwich Shop”, or consultation with other data sources available to the user 116, etc. If it appears that both are part of the same aggregate merchant, the user 116 might request further aggregation, in this example, and not confirm the data structure at 312 (or the user 116 may flag the data structure). However, if no such outliers are found or perceived when reviewing the merchant data structure, the user 116 may determine that further aggregation is not necessary and confirm the data structure at 312.

Further, if the manual review by the user 116 at 312 suggests that an aggregate merchant in the listing (in the merchant data structure) has more locations than identified or included in the merchant data structure entry, the analyst user 116 may determine that the filters implemented to the transaction data (as discussed above) and/or the selected industry (and/or MCC) used to initially identify and aggregate the merchants at operation 308 are overly narrow. The user 116 may then, in turn, return to one of the prior operations (e.g., operation 304, etc.) to capture additional merchants for aggregation by identifying one or more additional industries for accessing transaction data, by removing one or more filters on the transaction data, etc. As a result, more accurate transaction data from a set of industries or for all merchant locations within the given target region (e.g., country) can be accessed by the engine 118.

Thus, at 312 in the method 300, when the user 116 confirms the data structure following his/her review, the engine 118 publishes the data structure (or a particular list or group of sorted aggregate merchants from the data structure), at 314, to the user 116, for example, as a list of sorted aggregate merchants. This may include, for example, displaying the list of sorted aggregate merchants (e.g., the list from Table 1, etc.) at the user's computing device 114, or transmitting a message including the list to the user 116, etc. What's more, as part of publishing the list of sorted aggregate merchants, the engine 118 may append additional transaction data and/or merchant data for each of the aggregate merchants into the list, thereby providing a more detailed report of the results. For example, the engine 118 may associate each aggregate merchant with a DBA name, an address (e.g., a street address, a city, a state, a postal code, etc.), a tax ID, an oil brand code, an acquiring interbank card association, an acquiring ID, or other data appropriate data prior to publishing the list of aggregate merchants to the user 116.

However, when the user 116 does not confirm the merchant data structure following his/her review at 312, the engine 118 generates, at 316, one or more additional, new pattern rules for the aggregate merchants in the merchant data structure. The additional pattern rules may include any suitable, new rules that help further identify various ones of the aggregate merchants in the merchant data structure that should be further combined as an aggregate merchant. Once generated, the additional pattern rules may be stored, by the engine 118, in memory 204. In some aspects, the additional pattern rules may be generated based on a geography associated with the merchants. For example, a merchant may be known by different names in different parts of a region. As such, the additional pattern rules may be specific to the different parts of the region, or the region as a whole, whereby the engine 118 would be able to aggregate the different merchant entries, despite the different names. In other aspects, the additional pattern rules may relate to short DBA name and/or MCC. The additional pattern rules could relate to other features of the aggregate merchants in other embodiments.

In addition at 316, or alternatively, the engine may score each of the aggregate merchants in the merchant data structure and, based on the resulting scores, determine which of the aggregated merchants should be further aggregated (e.g., when the resulting scores satisfy predefined thresholds, etc.). Various suitable techniques may be used to score the different aggregate merchants in the merchant data structure. For example, string matching techniques may be used, where data for one of the aggregate merchants (e.g., DBA name, address, combinations thereof, etc.) is compared to corresponding data for another one of the aggregate merchants and scored (e.g., on a range of zero to one where zero indicates no text commonality between the compared data and one indicates identity between the compared data, etc.) to determine degrees of similarity (based in predefined threshold values) between the data for the different aggregate merchants (and thus, whether or not the compared aggregate merchants should be further aggregated). With that said, example operations that may be used for scoring the aggregate merchants in the merchant data structure are provided in Applicant's co-owned U.S. Pat. No. 8,219,550, issued Jul. 10, 2012, U.S. application Ser. No. 13/791,078, filed Mar. 8, 2013, and U.S. application Ser. No. 14/054,340, filed Oct. 15, 2013, the entire disclosures of which are all incorporated herein by reference.

Upon completion of the further aggregation at 316, the engine 118 may revisit and/or rerun one or more of the operations at 308, 310, and 312, at a later time, or after various pattern rules constructed thereby have be adopted into one or more aggregation processes, to thereby provide a more complete identification of the aggregate merchants.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of: (a) compiling a merchant data structure based on a region, the merchant data structure including multiple merchants; (b) aggregating ones of the multiple merchants based on at least one rule including a Doing Business As (DBA) name and/or a Merchant Category Code (MCC); (c) sorting the aggregate merchants based on a merchant metric; (d) publishing the sorted aggregate merchants to a user; and (e) limiting the aggregate merchants in the merchant data structure based on a MCC associated with a client inquiry.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “connected to,” “in communication with,” or “coupled to” another element, it may be directly on, connected or coupled to or in communication with the other element, or intervening elements may be present. In contrast, when an element is referred to as being “directly on,” “directly connected to,” “directly in communication with,” or “directly coupled to” another element, there may be no intervening elements present.

As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature could be termed a second feature without departing from the teachings of the exemplary embodiments.

What is claimed is:

1. A computer-implemented method for identifying one or more aggregate merchants within a region, the method comprising:
compiling, by a computing device, a merchant data structure based on a region, the merchant data structure including multiple merchants and, for each of the multiple merchants, a Doing Business As (DBA) name and at least one merchant metric;
aggregating, by the computing device, ones of the multiple merchants in the merchant data structure based on at least one rule including the DBA name and/or at least one Merchant Category Code (MCC);
sorting, by the computing device, the aggregate merchants in the merchant data structure based on the at least one merchant metric; and
publishing the sorted aggregate merchants in the merchant data structure to a user.

2. The computer-implemented method of claim 1, wherein compiling the merchant data structure includes compiling the merchant data structure further based on at least one industry.

3. The computer-implemented method of claim 2, further comprising limiting, by the computing device, the aggregate merchants in the merchant data structure based on at least one MCC associated with a client inquiry; and
wherein sorting the aggregate merchants includes sorting the limited aggregate merchants.

4. The computer-implemented method of claim 1, wherein the merchant metric includes one of: a number of locations for the aggregate merchant, a total spend at the aggregate merchant within a predefined interval, and/or a number of transactions at the aggregate merchant within a predefined interval.

5. The computer-implemented method of claim 1, further comprising receiving a request, based on a client inquiry, to identify aggregate merchants, the request indicating an industry and a region code associated with the region; and
wherein compiling the merchant data structure includes compiling the merchant data structure based on an industry code associated with said industry and the region code.

6. The computer-implemented method of claim 1, wherein publishing the sorted aggregate merchants includes publishing the sorted aggregate merchants after a manual review confirms the merchants.

7. The computer-implemented method of claim 6 further comprising generating pattern rules, for the aggregate merchants, based on DBA names and/or MCCs included in the sorted aggregate merchants in the merchant data structure and further based on a geography associated with the sorted aggregated merchants, when the manual review does not confirm the merchants.

8. The computer-implemented method of claim 1, wherein publishing the sorted aggregate merchants includes appending further merchant data to the merchant data structure, for each sorted aggregate merchant.

9. The computer-implemented method of claim 8, wherein the further merchant data includes, for each sorted aggregate merchant, at least one of: a merchant tax ID, an acquiring interbank card association (ICA), an acquiring ID, and/or an oil brand code.

10. The computer-implemented method of claim 1, further comprising:
generating a score for at least one of the aggregate merchants based on a comparison of at least a DBA name for said at least one of the aggregate merchants and another one of the aggregate merchants; and
aggregating said at least one of the aggregate merchants and said another one of the aggregate merchants when the score satisfies a predefined threshold.

11. One or more non-transitory computer readable storage media having computer-executable instructions embodied thereon that, when executed by at least one processor, cause the at least one processor to:
compile a merchant data structure based on at least one of a region and an industry, the merchant data structure including multiple merchants located within the region;
limit the merchant data structure based on at least one MCC based on a client inquiry;
aggregate ones of the multiple merchants in the limited merchant data structure based on at least one rule, the at least one rule relating to a Doing Business As (DBA) name and at least one Merchant Category Code (MCC) pair;
sort the aggregated merchants based on at least one merchant metric; and
publish the sorted aggregated merchants to a user.

12. The one or more non-transitory computer readable storage media of claim 11, wherein the merchant metric includes one of: a total spend at the aggregate merchant within a predefined interval or a number of consumers associated with the aggregate merchant.

13. The one or more non-transitory computer readable storage media of claim 11, wherein when executed by the at least one processor, the computer-executable instructions further cause the at least one processor to receive a request from the user to identify the aggregate merchants; and
wherein the request defines the region, the industry and the at least one MCC used to limit the merchant data structure.

14. The one or more non-transitory computer readable storage media of claim 11, wherein when executed by the at least one processor, the computer-executable instructions cause the at least one processor, in order to publish the sorted aggregate merchants, to append additional merchant data to the data structure associated with each of the sorted aggregate merchants.

15. The one or more non-transitory computer readable storage media of claim 11, wherein when executed by the at least one processor, the computer-executable instructions cause the at least one processor, in order to compile a merchant data structure, to compile a merchant data structure, whereby each of the multiple merchants is associated with a country code indicative of the region and an industry code assigned to the industry.

16. The one or more non-transitory computer readable storage media of claim 11, wherein when executed by the at least one processor, the computer-executable instructions further cause the at least one processor to generate at least one pattern rule, based on the aggregate merchants.

17. The one or more non-transitory computer readable storage media of claim 16, wherein the pattern rule is based on a short DBA name and a geography associated with the aggregated merchants.

18. A computing device for identifying aggregate merchants within a region, the computing device comprising:
at least one processor configured to:
compile a merchant data structure based on transaction data accessed from a payment network associated with a region and an industry, the merchant data structure including multiple merchants located within the region, as identified from the industry;
access pattern rules in a memory associated with the at least one processor, each pattern rule including a pair of at least one Doing Business As (DBA) name and at least one Merchant Category Code (MCC);
aggregate ones of the merchants in the merchant data structure based on the accessed pattern rules;
limit the aggregated merchants in the merchant data structure based on at least one MCC associated with a client inquiry;
sort the limited aggregate merchants in the merchant data structure based on at least one merchant metric associated with a client inquiry; and
publish the sorted aggregate merchants to a user.

19. The computing device of claim 18, where the at least one processor is further configured to generate at least one new additional pattern rule for the aggregate merchants in the merchant data structure, in response to at least one input from a user, and to store the at least one new pattern rule in the memory.

20. The computing device of claim 18, wherein the merchant metric includes one of a number of locations for the aggregate merchant and/or a total spend at the aggregate merchant within a predefined interval.
